(19) United States
(12) Patent Application Publication
(10) Pub. No.: US 2026/0202824 A1
(43) Pub. Date: Jul. 16, 2026

(54) PROCESSING DEVICE, ROBOT SYSTEM, PROCESSING METHOD, AND RECORDING MEDIUM

(71) Applicant: NEC Corporation, Tokyo (JP)

(72) Inventors: Masumi ICHIEN, Tokyo (JP); Kei TAKAYA, Tokyo (JP)

(73) Assignee: NEC Corporation, Tokyo (JP)

(21) Appl. No.: 19/137,690

(22) PCT Filed: Dec. 21, 2022
(86) PCT No.: PCT/JP2022/047017

§ 371 Date: Jun. 11, 2025

(51) Int. Cl. G05B 19/4155; B25J 9/16

(52) U.S. Cl. CPC G05B 19/4155; B25J 9/161; B25J 9/1697; G05B 2219/40113

(57) ABSTRACT

A processing device includes a memory configured to store instructions; and a processor configured to execute the instructions to acquire first information about a first state of a target object at a first position, second information about a second state of the target object at a second position, third information about a third state of the target object in an action that is performed between the first position and the second position, and fourth information about an area where the target object is placeable in an inclined state and generate an action plan of a robot related to the target object so that an action to be performed on the target object from the first information to the second information is performed via the third information. The action plan includes an action for placing the target object in the area.

### TECHNICAL FIELD

The present disclosure relates to a processing device, a robot system, a processing method, and a recording medium.

### BACKGROUND ART

Robots that grasp physical objects are used in various fields including logistics and the like. Patent document 1 discloses technology in which a robot re-grasps an object and causes a device to read an object code as related technology.

### PRIOR ART DOCUMENTS

### Patent Document

Patent Document 1: Japanese Unexamined Patent Application, First Publication No. H05-303660

### SUMMARY

### Technical Problem

In the technology described in Patent Document 1, there is a possibility that an object will be re-grasped multiple times. Therefore, in a case where a target object is moved from a certain position to a destination using the technology described in Patent Document 1, it is difficult to generate an overall action plan for moving the target object from the certain position to the destination in one go in a case where an action for causing a device to read an object code or the like on the way is performed.

An objective of each example aspect of the present disclosure is to provide a processing device, a robot system, a processing method, and a recording medium that can solve the above problems.

### Solution to Problem

According to an example aspect of the present disclosure for achieving the above-described objective, there is provided a processing device including: an acquisition means configured to acquire first information about a first state of a target object at a first position, second information about a second state of the target object at a second position, third information about a third state of the target object in an action that is performed between the first position and the second position, and fourth information about an area where the target object is placeable in an inclined state; and a generation means configured to generate an action plan of a robot related to the target object so that an action to be performed on the target object from the first information to the second information acquired by the acquisition means is performed via the third information, wherein the action plan includes an action for placing the target object in the area.

According to another example aspect of the present disclosure for achieving the above-described objective, there is provided a robot system including: the above-described processing device; and the robot configured to be controlled based on the action plan generated by the processing device.

According to yet another example aspect of the present disclosure for achieving the above-described objective, there is provided a processing method including: acquiring first information about a first state of a target object at a first position, second information about a second state of the target object at a second position, third information about a third state of the target object in an action that is performed between the first position and the second position, and fourth information about an area where the target object is placeable in an inclined state; and generating an action plan of a robot related to the target object so that an action to be performed on the target object from the acquired first information to the acquired second information is performed via the third information, wherein the action plan includes an action for placing the target object in the area.

According to yet another example aspect of the present disclosure for achieving the above-described objective, there is provided a recording medium storing a program for causing a computer to: acquire first information about a first state of a target object at a first position, second information about a second state of the target object at a second position, third information about a third state of the target object in an action that is performed between the first position and the second position, and fourth information about an area where the target object is placeable in an inclined state; and generate an action plan of a robot related to the target object so that an action to be performed on the target object from the acquired first information to the acquired second information is performed via the third information.

### Advantageous Effects of Invention

According to each example aspect of the present disclosure, in a case where a target object is moved from a certain position to a destination, even if a certain action is performed on the way, it is possible to generate an overall action plan for moving the target object from the certain position to the destination in one go.

### BRIEF DESCRIPTION OF DRAWINGS

FIG. 1 is a diagram showing an example of a configuration of a robot system according to an example embodiment of the present disclosure.

FIG. 2 is a diagram showing an example of a configuration of a processing device according to an example embodiment of the present disclosure.

FIG. 3 is a diagram showing an example of labeled data in a first example embodiment of the present disclosure.

FIG. 4 is a diagram showing a first specific example of action content generated by a generation unit according to an example embodiment of the present disclosure.

FIG. 5 is a diagram showing a second specific example of action content generated by the generation unit according to an example embodiment of the present disclosure.

FIG. 6 is a diagram showing a third specific example of action content generated by the generation unit according to an example embodiment of the present disclosure.

FIG. 7 is a diagram showing an example of a sequence of an action plan generated by the generation unit according to an example embodiment of the present disclosure.

FIG. 8 is a diagram showing an example of a control signal corresponding to the action plan generated by a control unit according to an example embodiment of the present disclosure.

FIG. 9 is a diagram showing an example of a processing flow of the robot system according to an example embodiment of the present disclosure.

FIG. 10 is a diagram showing an example of a configuration of a robot according to another example embodiment of the present disclosure.

FIG. 11 is a diagram showing an example of the processing device with a minimum configuration according to an example embodiment of the present disclosure.

FIG. 12 is a diagram showing an example of a processing flow of the processing device with the minimum configuration according to an example embodiment of the present disclosure.

FIG. 13 is a schematic block diagram showing a configuration of a computer according to at least one example embodiment.

### EXAMPLE EMBODIMENT

Example embodiments will be described in detail below with reference to the drawings.

### Example Embodiment

A robot system 1 according to one example embodiment of the present disclosure is a system for moving a target object M placed at a certain position (an example of a first position) to a destination (an example of a second position) and is a system for generating a robot action plan for changing a state of the target object M in accordance with an operation performed between the certain position and the destination. The certain position is an initial position of the target object M before the movement in the robot action plan. The destination is a final position indicating a movement destination of the target object M in the robot action plan. Examples of the certain position and the destination include, for example, a cardboard box (where the target object M is packed or for packing the target object M), a tray (where the target object M is sorted or for sorting the target object M), and the like. Examples of the action performed between the certain position and the destination include an action for reading a barcode assigned to the target object M, an action for measuring dimensions of the target object M, and the like. The robot system 1 is a system that is introduced, for example, in a warehouse of a logistics center or the like. The robot system 1 will be described below using the tray T as a specific example of the certain position, the cardboard box C as a specific example of the destination, and the action for reading the barcode assigned to the target object M as a specific example of the action performed between the certain position and the destination.

### Configuration of Robot System

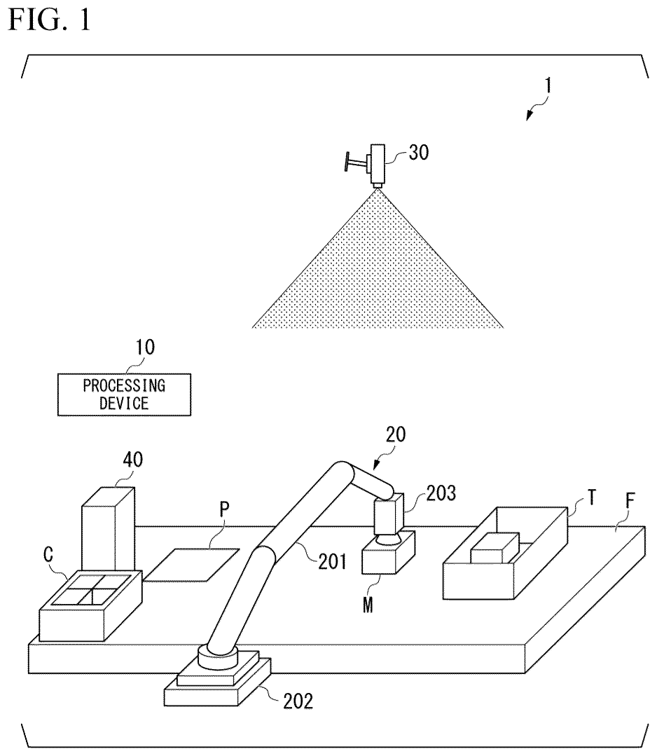

FIG. 1 is a diagram showing an example of a configuration of the robot system 1 according to an example embodiment of the present disclosure. As shown in FIG. 1, the robot system 1 includes a processing device 10, a robot 20, an imaging device 30, and a barcode reader 40. In addition, a floor surface F, the target object M, the tray T, the cardboard box C, and an area P for changing a state of the target object M are shown in FIG. 1. Although the area P is shown as a part of the floor surface F in FIG. 1, the area P is not limited to the part of the floor surface F. For example, the area P may be a part of a table independent of the floor surface F. Moreover, the area P of the table is not limited to a surface parallel to the floor surface F, and may be an area of a table having a single plane having a surface oblique to the floor surface F or an area of a table having a surface combining two or more surfaces. The robot system 1 will be described below using a case where the robot system 1 causes the barcode reader 40 to read the barcode assigned to the target object M between the tray T and the cardboard box C and moves the target object M from the tray T to the cardboard box C as an example.

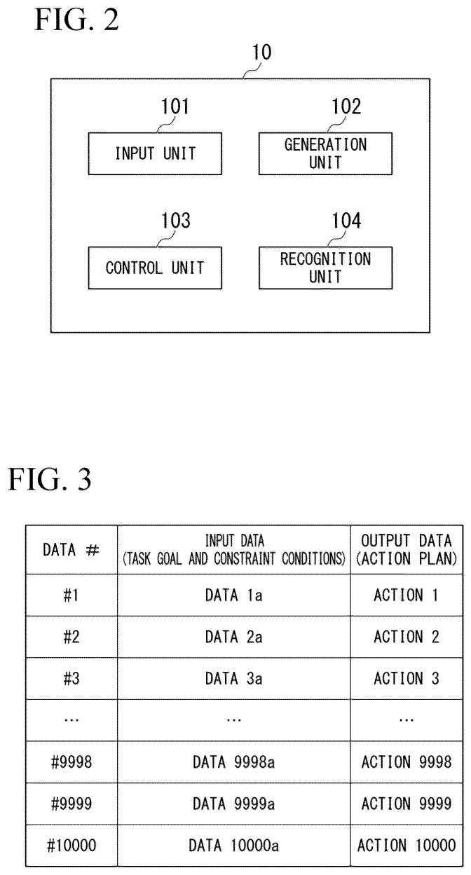

FIG. 2 is a diagram showing an example of a configuration of the processing device 10 according to an example embodiment of the present disclosure. As shown in FIG. 2, the processing device 10 includes an input unit 101, a generation unit 102 (an example of an acquisition means and an example of a generation means), a control unit 103 (an example of a control means), and a recognition unit 104.

The input unit 101 inputs a task goal and constraint conditions to the generation unit 102. Examples of the task goal include information (an example of first information) about a state (an example of a first state) of the target object M at a certain position (an example of a first position), information (an example of second information) about a state (an example of a second state) of the target object M at a destination (an example of a second position), information (an example of third information) about a state (an example of a third state) of the target object M in an action performed between a certain position and the destination, information (an example of fourth information) about an area provided for changing the state of the target object M, and the like. The information about the state includes information about a position and a posture. Examples of the constraint conditions include an entry prohibition area in a case where the target object M is moved, an area that deviates from a movable range of the robot 20, and the like. Moreover, a position of the target object M identified in an image captured by the imaging device 30 may be set as a movement source of the target object M. Moreover, the input unit 101, for example, may receive a position of an obstacle during the movement of the target object M from the movement source to the destination as a constraint condition indicating the entry prohibition area and input its information to the generation unit 102. Moreover, a file indicating the constraint conditions may be stored in a storage device and the input unit 101 may input the constraint conditions indicated in the file to the generation unit 102 and/or the generation unit 102 may read the constraint conditions from the file. In other words, as long as the generation unit 102 can acquire a necessary task goal and necessary constraint conditions, any acquisition method may be used.

The generation unit 102 generates an action plan indicating a flow of an action of the robot 20 based on the task goal and the constraint conditions input by the input unit 101. For example, in a case where the task goal and the constraint conditions are input by the input unit 101, the generation unit 102 acquires an image of a movement source of the target object M indicated by the task goal from the imaging device 30. The generation unit 102 can recognize a state (i.e., a position and a posture) of the target object M at the movement source from the image acquired from the imaging device 30. The generation unit 102 generates a movement path including the states of the target object M from the state of the target object M at the movement source to the state of the target object M at the destination of the target object M via the area P with, for example, a simulation, so that a quantity of control applied to the posture of the target object M is minimized. Information indicating the movement path is information necessary for the control unit 103 to generate a control signal for controlling the robot 20. Also, the generation unit 102 generates information (i.e., a sequence (a part of the action plan)) indicating a state of the robot 20 at each intermediate time step (such as a type (including a shape) of the target object M, a position and a posture of the robot 20, and an action of the robot 20 (such as a grasping force on the target object M)) with, for example, a simulation. The generation unit 102 outputs the generated sequence to the control unit 103.

In addition, the generation unit 102 may be implemented using artificial intelligence (AI) technology including temporal logic, reinforcement learning, optimization technology, and the like.

For example, the generation unit 102 may be based on a pre-trained model in which parameter values included in the model are decided by a supervised learning method. Moreover, for example, the generation unit 102 may calculate an action plan for moving the target object M and changing its state by defining the task goal and constraint conditions as an optimization problem. As the constraint conditions of the optimization problem, a position and a posture of the target object in its initial state, a position and a posture in its final state, a position and a posture during each task, the order of state changes of the target object so that a robot hand, a target object, and an obstacle are not contact (non-overlapping of areas of physical objects), and the like are conceivable. The constraint conditions are expressed, for example, by linear or nonlinear mathematical expressions. Moreover, as an objective function of the optimization problem, the minimization of a total movement distance or posture rotation amount of the robot hand, the minimization of time until the target object reaches the final state, and the like are conceivable. A linear or nonlinear mathematical expression is expressed as the objective function. By solving an optimization model in which constraint conditions and objective functions are set using a mathematical optimization algorithm, it is possible to calculate an action plan that optimizes a control quantity of the hand while satisfying the constraint conditions.

Specifically, the generation unit 102 predicts action content (i.e., a movement path for moving the target object M and an action plan including an action to be performed on the target object M) that minimizes the number of changes in the posture of the target object M by using a pre-trained model (e.g., a neural network) whose parameters are decided using labeled data. Here, a pre-trained model used by the generation unit 102 for each prediction process will be described.

### Pre-Trained Model

A pre-trained model will be described. The generation unit 102 predicts action content (i.e., an action plan including a movement path for moving the target object M and an action to be performed on the target object M) based on a task goal and constraint conditions for the action. Here, the pre-trained model in which the generation unit 102 predicts the action content based on the task goal and the constraint conditions will be described.

In this case, the task goal and the constraint conditions are input. Moreover, the action content (i.e., the action plan) actually set for the task goal and the constraint conditions is one output data item. Also, a combination of the input data and the output data corresponding to the input data is one labeled data item. For example, before the generation unit 102 predicts the action content, the output data (i.e., the action plan) is identified for input data used to predict the action content by another device. Alternatively, the output data is identified for the input data by, for example, performing an experiment or a simulation. In this way, labeled data consisting of a plurality of data items in which the input data and the output data are combined can be provided. In addition, the labeled data is used, for example, to decide a parameter value in a learning model in which the parameter value has not been decided.

FIG. 3 is a diagram showing an example of labeled data in the first example embodiment of the present disclosure. Input data, which is a task goal and a constraint condition, and output data (a label and action content in this example) for the input data become data of one set. In the example shown in FIG. 3, the labeled data includes data of 10,000 sets.

For example, a case where parameters in a learning model are decided using labeled data consisting of 10,000 sets of data shown in FIG. 3 is conceivable. In this case, the labeled data is divided into, for example, a training dataset, a validation dataset, and a test dataset. Examples of a percentage of the number of data items included in the training dataset, the validation dataset, and the test dataset include 70%, 15%, and 15%, 95%, 2.5%, and 2.5%, and the like. For example, it is assumed that labeled data of data #1 to #10000 are divided into the training dataset, the evaluation dataset, and the test dataset. The training dataset is, for example, data #1 to #7000. The evaluation dataset is, for example, data #7001 to #8500. The test dataset is, for example, data #8501 to #10000. In this case, the training dataset is input to a learning model such as a neural network. The neural network outputs action content according to a parameter value for the task goal and constraint conditions. In accordance with an error between the output and the label, for example, the neural network changes a parameter indicating the weighting of a data connection between nodes constituting the neural network by performing backpropagation (i.e., changing a model of the neural network). In this way, the training dataset is input to the neural network to adjust the parameters.

Next, data in the evaluation dataset (data #7001 to #8500 in this example) is input to the neural network with the changed parameters. The neural network outputs the action content actually set for the task goal and constraint conditions for the input data. The neural network compares the output content with the label for each data item in the validation dataset and calculates the error between the output and the label. In a case where the error does not satisfy a criterion for ending a parameter decision process, the neural network adjusts the parameter value again using the training dataset. In a case where the error satisfies the criterion, the neural network ends the parameter calculation process. The neural network (i.e., the learning model) of a case where the error satisfies the criterion is the pre-trained model.

Subsequently, data in the test dataset (data #8501 to #10000 in this example) is input to the pre-trained model. The neural network of the pre-trained model outputs the action content actually set for the task goal and constraint conditions according to the input test data. In a case where the pre-trained model has been obtained, the pre-trained model is recorded as the generation unit 102. Also, the generation unit 102 may predict the action content using this pre-trained model.

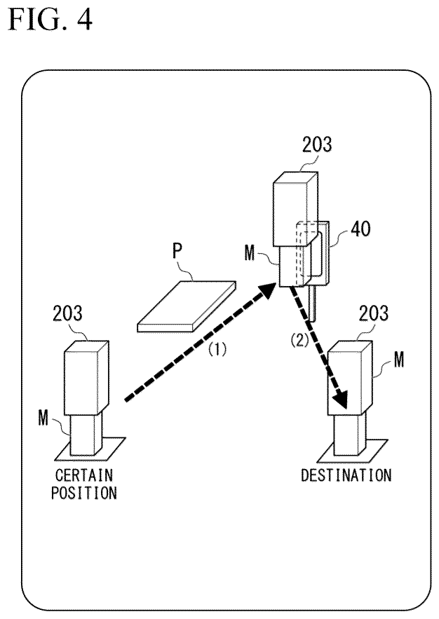

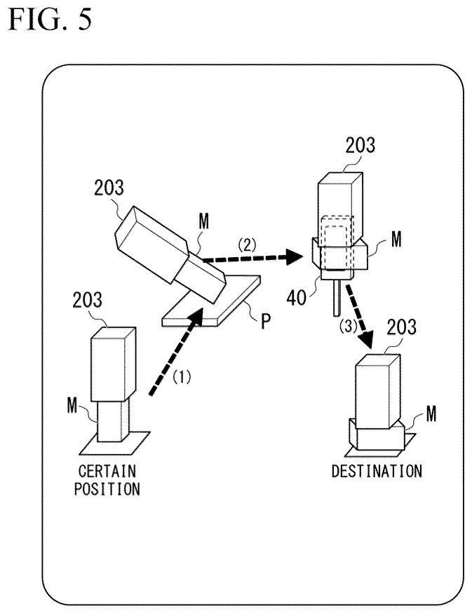

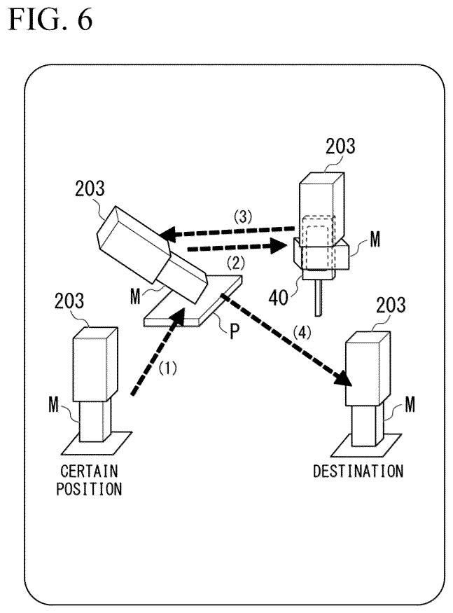

FIG. 4 is a diagram showing a first specific example of the action content generated by the generation unit 102 according to an example embodiment of the present disclosure. FIG. 5 is a diagram showing a second specific example of the action content generated by the generation unit 102 according to an example embodiment of the present disclosure. FIG. 6 is a diagram showing a third specific example of the action content generated by the generation unit 102 according to an example embodiment of the present disclosure. For example, in a case where the generation unit 102 is a pre-trained model for implementing the action content that minimizes the number of changes in the posture of the target object M, the generation unit 102 generates three types of action content (i.e., action plans) shown in FIGS. 4 to 6 in accordance with a task goal (i.e., information about the state of the target object M at a certain position, information about a state of the target object M at a destination, information about a state of the target object M in an action performed between a certain position and the destination, and information about an area provided for changing the state of the target object M).

FIG. 4 shows an image diagram of action content in which a robot hand 203 of the robot 20 to be described below grasps the target object M at a certain position, moves the target object M to the position of the barcode reader 40 while its posture is maintained, causes the barcode reader 40 to read a barcode assigned to the target object M, and further moves the target object M to the destination while its posture is maintained and places the target object M. In this case, the robot hand 203 does not need to re-grasp the target object M in the area P. Therefore, the generation unit 102 generates an action plan that does not include an action for re-grasping the target object M in the area P.

FIG. 5 shows an image diagram of action content in which the robot hand 203 of the robot 20 grasps the target object M at a certain position, moves the target object M to an area P while its posture is maintained, re-grasps the target object M in the area P to move the target object M to the position of the barcode reader 40, causes the barcode reader 40 to read a barcode assigned to the target object M, and further moves the target object M to the destination while its posture is maintained and places the target object M. In this case, the robot hand 203 needs to re-grasp the target object M in the area P one time before the barcode reader 40 is allowed to read the barcode assigned to the target object M. Therefore, the generation unit 102 generates an action plan including an action for re-grasping the target object M in the area P before the barcode reader 40 is allowed to read the barcode assigned to the target object M.

FIG. 6 shows an image diagram of action content in which the robot hand 203 of the robot 20 grasps the target object M at a certain position, moves the target object M to area P while its posture is maintained, re-grasps the target object M in the area P to move the target object M to the position of the barcode reader 40, causes the barcode reader 40 to read the barcode assigned to the target object M, further moves the target object M to the area P while its posture is maintained, re-grasps the target object M in the area P, moves the target object M to the destination while its posture is maintained and places the target object M. In this case, the robot hand 203 needs to re-grasp the target object M in the area P (i.e., re-grasp the target object M a total of two times) before and after the barcode reader 40 is allowed to read the barcode assigned to the target object M.

Therefore, the generation unit 102 generates an action plan including an action for re-grasping the target object M in the area P (i.e., re-grasping the target object M a total of two times) before and after the barcode reader 40 is allowed to read the barcode assigned to the target object M.

The generation unit 102 may decide whether or not to perform an action for re-grasping the target object M in accordance with a difference between the state of the target object M placed at a certain position (e.g., which side is the top side or the like) and the state of the target object M to be placed at the destination. Alternatively, the generation unit 102 may decide whether or not to perform an action for re-grasping the target object M in accordance with a difference between the state of the target object M placed at a certain position (e.g., which side is the top side or the like) and the state of the target object M in a case where the barcode is presented to the barcode reader.

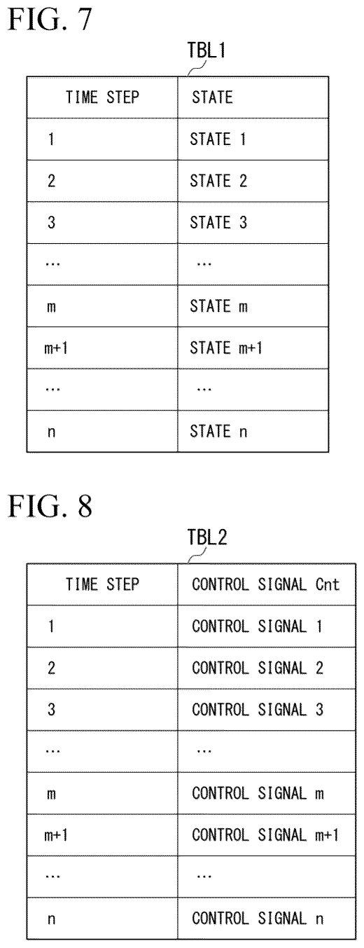

FIG. 7 is a diagram showing an example of a sequence TBL1 of an action plan generated by the generation unit 102 according to an example embodiment of the present disclosure. For example, as shown in FIG. 7, the sequence TBL1 of the action plan generated by the generation unit 102 is a sequence indicating the state of the robot 20 for each of n time steps from the movement source of the target object M to the destination.

The control unit 103 controls the robot 20 based on the action content (i.e., the action plan) generated by the generation unit 102. According to this control, the target object M moves from a certain position to the destination.

For example, the control unit 103 generates a control signal for controlling the robot 20 based on a sequence output by the generation unit 102. In addition, the control unit 103 may generate a control signal that optimizes an evaluation function in a case where the control signal is generated. Examples of the evaluation function include a function of minimizing the number of times the robot 20 changes the posture of the target object M in a case where the target object M is moved, a function of representing the amount of energy consumed by the robot 20, a function of representing a distance along a path on which the target object M is moved, and the like. The control unit 103 outputs the generated control signal to the robot 20.

FIG. 8 is a diagram showing an example of a control signal Cnt corresponding to an action plan generated by the control unit 103 according to an example embodiment of the present disclosure. For example, the control signal Cnt generated by the control unit 103 is a control signal for each time step obtained by dividing the time from the movement source of the target object M to the destination by n, as shown in FIG. 8.

The recognition unit 104 recognizes the target object M at a certain position. For example, the recognition unit 104 acquires an image including the target object M placed at a certain position from the imaging device 30. The recognition unit 104 recognizes a state (i.e., a position and a posture) of the target object M at the certain position from the image acquired from the imaging device 30. The recognition unit 104 outputs a recognized state of the target object M to the generation unit 102.

The robot 20 grasps the target object M in accordance with a control signal output by the control unit 103 and moves the target object M from the movement source to the destination by causing the barcode reader 40 to read the barcode assigned to the target object M on the way. As shown in FIG. 1, the robot 20 includes a robot arm 201, a pedestal 202, and the robot hand 203. The robot arm 201 is connected to the pedestal 202. The robot hand 203 is connected to an end opposite to an end where the robot arm 201 is connected to the pedestal 202. The robot hand 203 includes, for example, two or more pseudo-fingers resembling the fingers of a human or an animal, or a vacuum. The robot hand 203 grasps the target object M in accordance with a control signal output by the processing device 10. The robot arm 201 moves the target object M from the movement source to the destination in accordance with a control signal output by the processing device 10.

In addition, in each example embodiment of the present disclosure, a “grasp” includes “adsorption” in which the target object M is suctioned by a vacuum or the like and a “pinch” in which a physical object is pinched by two or more pseudo-fingers resembling fingers of a human or an animal.

The imaging device 30 captures the state of the target object M. The imaging device 30 is, for example, an industrial camera, and can identify the state (i.e., the position and the posture) of the target object M. An image captured by the imaging device 30 is output to the generation unit 102.

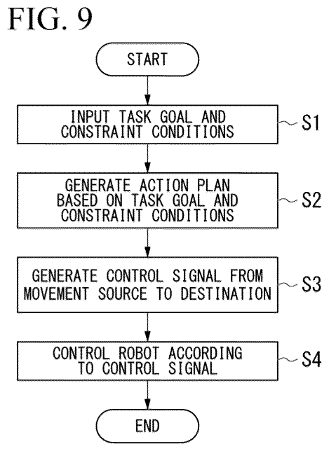

FIG. 9 is a diagram showing an example of a processing flow of the robot system 1 according to an example embodiment of the present disclosure. Next, details of the control of the robot 20 by the processing device 10 of the robot system 1 will be described with reference to FIG. 9. In addition, it is assumed that the task goal and constraint conditions are input to the input unit 101.

The input unit 101 inputs a task goal and constraint conditions to the generation unit 102 (step S1). The generation unit 102 generates an action plan indicating a flow of an action of the robot 20 based on the task goal and the constraint conditions input by the input unit 101 (step S2). Examples of the task goal include information (an example of first information) about a state (an example of a first state) of the target object M at a certain position (an example of a first position), information (an example of second information) about a state (an example of a second state) of the target object M at a destination (an example of a second position), information (an example of third information) about a state (an example of a third state) of the target object M in an action performed between a certain position and the destination, information (an example of fourth information) about an area provided for changing the state of the target object M, and the like. The generation unit 102 outputs a sequence, included in the generated action plan, for moving the target object M from the movement source (e.g., the tray T) to the destination by causing the barcode reader 40 to read the barcode assigned to the target object M on the way to the control unit 103.

The control unit 103 generates a control signal for performing a control process in which the robot hand 203 of the robot 20 grasps the target object M, causes the barcode reader 40 to read the barcode assigned to the target object M on the way, and move the target object M from the movement source to the destination, based on the sequence, output by the generation unit 102, for moving the target object M from the movement source to the destination by causing the barcode reader 40 to read the barcode assigned to the target object M on the way (step S3). The control unit 103 controls the robot 20 by outputting the generated control signal to the robot 20 (step S4). Thereby, the robot hand 203 of the robot 20 can grasp the target object M, causes the barcode reader 40 to read the barcode assigned to the target object M on the way, and moves the target object M from the movement source to the area P.

In addition, the control unit 103 may generate a new action plan for the target object M during control for moving the target object M from the movement source to the destination (i.e., review the action plan as necessary).

### Advantage

The robot system 1 according to an example embodiment of the present disclosure has been described above. In the robot system 1, the processing device 10 includes a generation unit 102 (an example of an acquisition means). The generation unit 102 acquires information (an example of first information) about a state (an example of a first state) of the target object M at a certain position (an example of a first position), information (an example of second information) about a state (an example of a second state) of the target object M at a destination (an example of a second position), information (an example of third information) about a state (an example of a third state) of the target object M in an action performed between the certain position and the destination (e.g., an action for causing the barcode reader 40 to read the barcode assigned to the target object M), and information (an example of fourth information) about the area P provided for changing the state of the target object M. Moreover, the generation unit 102 (an example of a generation means) generates an action plan for the robot 20 regarding the target object M based on the acquired information about the state of the target object M at the certain position, the acquired information about the state of the target object M at the destination, the acquired information about the state of the target object M in the action performed between the certain position and the destination, and the acquired information about the area P provided for changing the state of the target object M.

By doing so, the robot system 1 can generate an overall action plan for moving the target object from a certain position to a destination in one go, even if a certain action is performed on the way in a case where the target object is moved from the certain position to the destination.

In addition, in another example embodiment of the present disclosure, the processing device 10 may be provided in the robot 20.

In the robot system 1 according to an example embodiment of the present disclosure, a specific example of the generation unit 102 has been described as a pre-trained model. However, the generation unit 102 is not limited to the pre-trained model. For example, the generation unit 102 may have a function of determining whether or not it is necessary to review the posture of the target object M (i.e., it is necessary for the robot 20 to re-grasp the target object M) based on information (an example of first information) about a state (an example of a first state) of the target object M at a certain position (an example of a first position), information (an example of second information) about a state (an example of a second state) of the target object M at a destination (an example of a second position), information (an example of third information) about a state (an example of a third state) of the target object M in an action performed between a certain position and the destination, and information (an example of fourth information) about an area provided for changing the state of the target object M and may generate an action plan including an action for changing the state of the target object M in the area P in a case where it is determined that the state of the target object M needs to be changed.

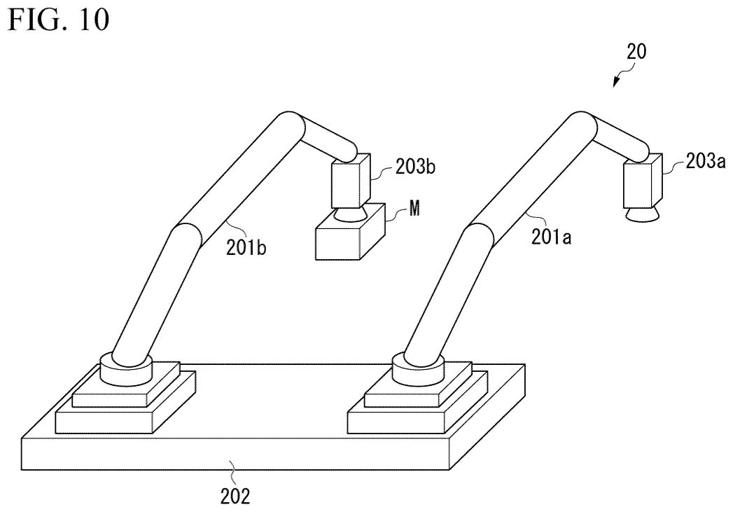

Moreover, the case where the robot 20 of the robot system 1 according to the example embodiment of the present disclosure includes the robot arm 201, the pedestal 202, and the robot hand 203, i.e., as a single-arm robot, has been described. However, the robot 20 of the robot system 1 according to another example embodiment of the present disclosure is not limited to the single-arm robot. FIG. 10 is a diagram showing an example of the configuration of the robot 20 according to another example embodiment of the present disclosure. As shown in FIG. 10, the robot 20 (an example of one robot) according to the other example embodiment of the present disclosure includes robot arms 201a, 201b, and the like, a pedestal 202, and robot hands 203a, 203b, and the like (an example of a grasping mechanism), i.e., the robot 20 may be a robot with two arms or three or more arms. The control unit 103 (an example of a control means) of the processing device 10 according to another example embodiment of the present disclosure generates a control signal for each of the plurality of arms (i.e., each of the robot arms 201a, 201b, and the like and the robot hands 203a, 203b, and the like) based on a sequence for moving the target object M from the movement source to the destination. This control signal causes each of the robot hands 203a, 203b, and the like to work together to move the target object M from the movement source to the destination.

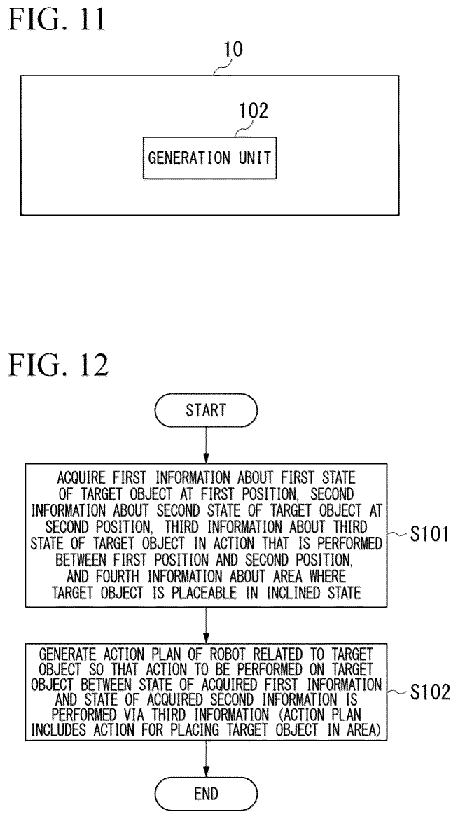

Next, a minimum configuration of the processing device 10 according to an example embodiment of the present disclosure will be described. FIG. 11 is a diagram showing an example of the processing device 10 with the minimum configuration according to an example embodiment of the present disclosure. As shown in FIG. 11, the processing device 10 with the minimum configuration includes a generation unit 102 (an example of an acquisition means and an example of a generation means). The generation unit 102 acquires first information about a first state of a target object at a first position, second information about a second state of the target object at a second position, third information about a third state of the target object in an action that is performed between the first position and the second position, and fourth information about an area where the target object is placeable in an inclined state. Moreover, the generation unit 102 generates an action plan of a robot related to the target object so that an action to be performed on the target object from the acquired first information to the acquired second information is performed via the third information. The action plan includes an action for placing the target object in the area. The generation unit 102 can be implemented, for example, by using the function provided in the generation unit 102 exemplified in FIG. 2.

Next, a process of the processing device 10 with the minimum configuration will be described. FIG. 12 is a diagram showing an example of a processing flow of the processing device 10 with the minimum configuration according to an example embodiment of the present disclosure. Here, the process of the processing device 10 with the minimum configuration will be described with reference to FIG. 12.

The generation unit 102 acquires first information about a first state of a target object at a first position, second information about a second state of the target object at a second position, third information about a third state of the target object in an action that is performed between the first position and the second position, and fourth information about an area where the target object is placeable in an inclined state (step S101). In addition, the generation unit 102 generates an action plan of a robot related to the target object so that an action to be performed on the target object from the acquired first information to the acquired second information is performed via the third information (the action plan includes an action for placing the target object in the area) (step S102).

The processing device 10 with the minimum configuration according to the example embodiment of the present disclosure has been described above. In a case where a target object is moved from a certain position to a destination, even if a certain action is performed on the way, the processing device 10 can generate an overall action plan for moving the target object from the certain position to the destination in one go.

Moreover, the order of the processing steps in the example embodiments of the present disclosure may be changed within a range in which appropriate processing steps are performed.

Moreover, the processes in the example embodiments of the present disclosure may be combined within a range in which appropriate processes are performed.

The example embodiments of the present disclosure have been described, but the robot system 1, the processing device 10, the input unit 101, the generation unit 102, the control unit 103, the recognition unit 104, the robot 20, the imaging device 30, and other control devices may internally have a computer device. The above-described processing steps are stored in a computer-readable recording medium in the form of a program, and the computer reads and executes this program to perform the above-described process. A specific example of a computer is shown below.

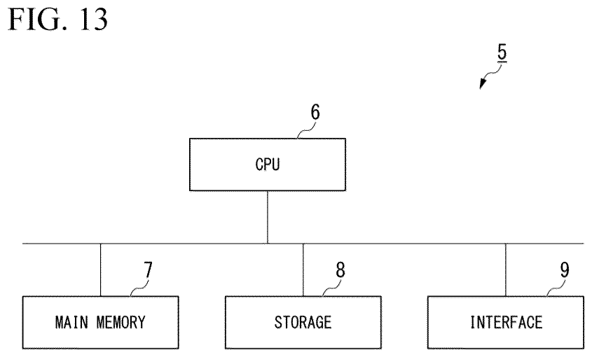

FIG. 13 is a schematic block diagram showing a configuration of a computer according to at least one example embodiment. As shown in FIG. 13, a computer 5 includes a central processing unit (CPU) 6, a main memory 7, a storage 8, and an interface 9. For example, each of the robot system 1, the processing device 10, the input unit 101, the generation unit 102, the control unit 103, the recognition unit 104, the robot 20, the imaging device 30, and other control devices is installed in the computer 5. Also, the operation of each processing unit described above is stored in the storage 8 in the form of a program. The CPU 6 reads the program from the storage 8, loads the program into the main memory 7, and executes the above-described process in accordance with the program. Moreover, the CPU 6 secures a storage area corresponding to each of the above-described storage units in the main memory 7 in accordance with the program.

Examples of the storage 8 include a hard disk drive (HDD), a solid-state drive (SSD), a magnetic disk, a magneto-optical disk, a compact disc read-only memory (CD-ROM), a digital versatile disc read-only memory (DVD-ROM), a semiconductor memory, and the like. The storage 8 may be an internal medium directly connected to a bus of the computer 5 or an external medium connected to the computer 5 via the interface 9 or a communication line. Also, in a case where the above program is distributed to the computer 5 via a communication line, the computer 5 receiving the distributed program may load the program into the main memory 7 and execute the above process. In at least one example embodiment, the storage 8 is a non-transitory tangible storage medium.

Moreover, the program may be a program for implementing some of the above-mentioned functions. Furthermore, the program may be a file for implementing the above-described function in combination with another program already stored in the computer device, a so-called differential file (differential program).

Although several example embodiments of the present disclosure have been described, these example embodiments are merely examples and do not limit the scope of the disclosure. These example embodiments may be variously added, omitted, replaced, or modified without departing from the spirit of the disclosure.

In addition, some or all of the above-described example embodiments may be described as in the following supplementary notes, but are not limited to the following supplementary notes.

### Supplementary Note 1

A processing device including:
an acquisition means configured to acquire first information about a first state of a target object at a first position, second information about a second state of the target object at a second position, third information about a third state of the target object in an action that is performed between the first position and the second position, and fourth information about an area where the target object is placeable in an inclined state; and
a generation means configured to generate an action plan of a robot related to the target object so that an action to be performed on the target object from the first information to the second information acquired by the acquisition means is performed via the third information, wherein the action plan includes an action for placing the target object in the area.

### Supplementary Note 2

The processing device according to supplementary note 1, including a control means configured to control the robot based on the action plan.

### Supplementary Note 3

The processing device according to supplementary note 1 or 2, wherein the generation means includes a trained neural network whose parameters are decided based on labeled data in which the first information, the second information, the third information, and the fourth information are designated as inputs and the action plan is designated as an output.

### Supplementary Note 4

The processing device according to supplementary note 1 or 2, wherein the generation means determines whether or not to change a state of the target object based on the first information, the second information, the third information, and the fourth information and generates the action plan including an action for changing the state of the target object in the area in a case where it is determined to change the state of the target object.

### Supplementary Note 5

A robot system including:
the processing device according to any one of supplementary notes 1 to 4; and
the robot configured to be controlled based on the action plan generated by the processing device.

### Supplementary Note 6

A processing method including:
acquiring first information about a first state of a target object at a first position, second information about a second state of the target object at a second position, third information about a third state of the target object in an action that is performed between the first position and the second position, and fourth information about an area where the target object is placeable in an inclined state; and
generating an action plan of a robot related to the target object so that an action to be performed on the target object from the acquired first information to the acquired second information is performed via the third information, wherein the action plan includes an action for placing the target object in the area.

### Supplementary Note 7

A recording medium storing a program for causing a computer to:
acquire first information about a first state of a target object at a first position, second information about a second state of the target object at a second position, third information about a third state of the target object in an action that is performed between the first position and the second position, and fourth information about an area where the target object is placeable in an inclined state; and
generate an action plan of a robot related to the target object so that an action to be performed on the target object from the acquired first information to the acquired second information is performed via the third information.

### Industrial Applicability

According to each example aspect of the present disclosure, in a case where a target object is moved from a certain position to a destination, even if a certain action is performed on the way, it is possible to generate an overall action plan for moving the target object from the certain position to the destination in one go.

### Reference Signs List

1 Robot system
5 Computer
6 CPU
7 Main memory
8 Storage
9 Interface
10 Processing device
20 Robot
30 Imaging device
101 Input unit
102 Generation unit
103 Control unit
104 Recognition unit
201 Robot arm
202 Pedestal
203 Robot hand
C Cardboard box
F Floor surface
M Target object
P Area
T Tray

What is claimed is:

1. A processing device comprising:
a memory configured to store instructions; and
a processor configured to execute the instructions to:
acquire first information about a first state of a target object at a first position, second information about a second state of the target object at a second position, third information about a third state of the target object in an action that is performed between the first position and the second position, and fourth information about an area where the target object is placeable in an inclined state; and
generate an action plan of a robot related to the target object so that an action to be performed on the target object from the first information to the second information is performed via the third information,
wherein the action plan includes an action for placing the target object in the area.

2. The processing device according to claim 1, wherein the processor is configured to execute the instructions to control the robot based on the action plan.

3. The processing device according to claim 1, 2, wherein the memory stores a trained neural network whose parameters are decided based on labeled data in which the first information, the second information, the third information, and the fourth information are designated as inputs and the action plan is designated as an output.

4. The processing device according to claim 1, wherein the processor is configured to execute the instructions to determine whether or not to change a state of the target object based on the first information, the second information, the third information, and the fourth information and generates the action plan including an action for changing the state of the target object in the area in a case where it is determined to change the state of the target object.

5. A robot system comprising:
the processing device according to claim 1; and
the robot configured to be controlled based on the action plan generated by the processing device.

6. A processing method comprising:
acquiring first information about a first state of a target object at a first position, second information about a second state of the target object at a second position, third information about a third state of the target object in an action that is performed between the first position and the second position, and fourth information about an area where the target object is placeable in an inclined state; and
generating an action plan of a robot related to the target object so that an action to be performed on the target object from the acquired first information to the acquired second information is performed via the third information,
wherein the action plan includes an action for placing the target object in the area.

7. A non-transitory recording medium storing a program for causing a computer to:
acquire first information about a first state of a target object at a first position, second information about a second state of the target object at a second position, third information about a third state of the target object in an action that is performed between the first position and the second position, and fourth information about an area where the target object is placeable in an inclined state; and
generate an action plan of a robot related to the target object so that an action to be performed on the target object from the acquired first information to the acquired second information is performed via the third information, the action plan including an action for placing the target object in the area.
